(19) United States
(12) Patent Application Publication
(10) Pub. No.: US 2021/0147753 A1
(43) Pub. Date: May 20, 2021

(54) REFORMING METHOD AND SYSTEM FOR UPGRADING OLEFIN-CONTAINING NAPHTHA

(71) Applicant: ExxonMobil Research and Engineering Company, Annandale, NJ (US)

(72) Inventors: Mohsen N. Harandi, New Hope, PA (US); Yira Y. Aponte Torrealba, Sarnia (CA)

(21) Appl. No.: 17/092,427

(22) Filed: Nov. 9, 2020

Related U.S. Application Data
(60) Provisional application No. 62/936,004, filed on Nov. 15, 2019.

(51) Int. Cl. C10G 69/02; B01J 19/24

(52) U.S. Cl. CPC C10G 69/02; B01J 19/245; C10G 2300/4006; C10G 2300/4012; C10G 2300/305; B01J 2219/0004; C10G 2300/104; C10G 2300/4018; C10G 2300/202

(57) ABSTRACT

A method for upgrading olefin-containing naphtha can include injecting a hydrocarbon stream containing an olefin-containing naphtha comprising olefins and diolefins in a reforming reactor at temperatures of from about 700° F. to about 1200° F. and pressures of from about 10 psig to about 500 psig to produce a reformate stream, which is then contacted with an atmosphere comprising hydrogen in a hydrotreating reactor to produce a product stream, wherein the reformate stream comprises at least 50% less diolefins than the hydrocarbon stream and the product stream comprises at least 99% less diolefins than the hydrocarbon stream. A system for upgrading olefin-containing naphtha may include a reforming reactor configured to receive a hydrocarbon stream containing an olefin-containing naphtha comprising olefins and diolefins, which produces a reformate stream, and a hydrotreating reactor configured to receive the reformate stream.

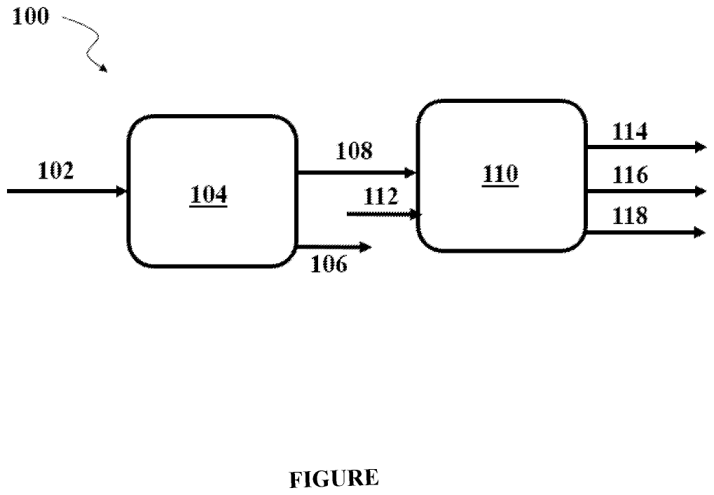

### CROSS-REFERENCE TO RELATED APPLICATIONS

This application claims the benefit of priority from U.S. Provisional Application No. 62/936,004 filed Nov. 15, 2019, which is herein incorporated by reference in its entirety.

### BACKGROUND OF THE INVENTION

This disclosure relates to methods and systems for the conversion of hydrocarbon feedstocks, in particular, olefin-containing naphtha feedstocks into higher octane (aromatics-rich) products and purer chemical feedstocks (benzene, toluene, xylenes, which are also known as BTX). In particular, this disclosure relates to improving the upgrading of olefin-containing naphtha by achieving the reforming process in two catalytic steps and obtaining a reformate product without the need for pretreatment of the naphtha to saturate the olefins and without the need for downstream reforming.

Naphtha reforming has been an important refining process for decades, generating hydrogen, BTX, and high-octane gasoline. A typical naphtha feedstock will contain paraffins, olefins, naphthenes, aromatics, and isomers thereof. To reform a typical naphtha feedstock into gasoline and/or BTX, a reforming catalyst converts these molecules into aromatics. In view of the growing demand for octane or useful petrochemicals including BTX, there is interest in the conversion of alternative feedstocks into such useful products. Alternative feedstocks include cracked naphtha and/or coker naphtha. In particular, cracked and/or coker naphthas are hydrocarbon streams produced by the thermal cracking of long chain hydrocarbons in a coker unit. During oil refinery processing, the coker unit converts residual oil from a distillation column into shorter chain hydrocarbons, including low molecular weight hydrocarbon gases and naphtha. Cracked naphtha and coker naphtha may contain unsaturated hydrocarbons such as olefins, diolefins and aromatics, as well as sulfur and nitrogen compounds.

Catalytic reforming may be used to upgrade olefin-containing naphthas such as cracked naphtha and coker naphtha. Reforming may be considered as changing the molecular structure of various hydrocarbons in a hydrocarbon feedstock to produce a reformate product. Such change may generally be carried out by combinations of chemical reactions involving dehydrogenation, dehydrocyclization, isomerization, and hydrocracking of the various hydrocarbons. The reformate product is typically referred to as reformate.

The reforming process may be carried out using a reforming catalyst, which becomes coked as the process is carried out. A multifunctional catalyst may be employed, which contains a metal hydrogenation-dehydrogenation (hydrogen transfer) component or components.

During the reforming process, sulfur impurities may be removed by hydrotreating, and diolefin impurities may be hydrogenated into saturated compounds in order to comply with the relevant product specifications. For example, when a highly unsaturated stock such as coker naphtha is used as feedstock, a separate additional reactor may be installed ahead of the main reactor. The purpose of this reactor is to saturate diolefins under mild conditions to extend the cycle length of the main hydrotreater reactor. In addition, olefinic feedstocks tend to form excessive amounts of coke in the reformer reactors and cause more rapid deactivation of the reforming catalyst. Consequently, reformers are typically equipped with pretreaters that catalytically react coker naphtha feedstock with hydrogen to saturate olefins and to remove sulfur compounds that could poison the reforming catalyst. Hydrogen consumption is related to the concentration of olefinic compounds in the pretreater feed and, as a result, olefinic feeds consume significantly more hydrogen during pretreatment than typical naphtha feedstocks, making olefin-containing naphtha feedstocks more costly to pretreat.

Accordingly, the reforming process relating to olefin-containing naphtha feedstocks such as cracker naphtha and coker naphtha is complicated by several issues. Diolefins and sulfur in the naphtha stream may cause reactor fouling resulting in reliability issues and the need to halt production. The reforming of naphtha may also require an increased exotherm in the hydrotreating unit resulting in narrower operating windows. Further, the reforming process may require high hydrogen consumption due to the high amount of olefins, diolefins, and sulfur/nitrogen compounds present in the olefin-containing naphtha. C₅-C₆ paraffins may be present as well in the naphtha feed stream, which may result in a lower overall octane increase due to the difficulty of reforming these paraffins.

As such, a reforming system and method that that can effectively convert hydrocarbon feedstocks having high amounts of olefins, diolefins and sulfur impurities into aromatics-rich products without the need to shut down hydrotreating units due to increased isotherms or the fast fouling of the reactor, are needed.

### SUMMARY OF THE INVENTION

This disclosure relates to methods and systems for the conversion of hydrocarbon feedstocks, in particular, olefin-containing naphtha feedstocks into higher octane (aromatics-rich) products and purer chemical feedstocks (BTX). In particular, this disclosure relates to improving the upgrading of olefin-containing naphtha by achieving the reforming process in two catalytic steps and obtaining a reformate product without the need for pretreatment of the naphtha to saturate the olefins and without the need for downstream reforming. This is achieved while a less low value C2- byproduct is made compared to conventional reforming.

Methods described herein may comprise injecting a hydrocarbon stream comprising at least about 20 weight percent of olefins and from 0.001 to about 30 weight percent of diolefins in a reforming reactor comprising a reforming catalyst at reforming conditions comprising temperatures of from about 700° F. to about 1200° F. and pressures of from about 10 psig to about 500 psig to produce a reformate stream; and contacting the reformate stream with an atmosphere comprising hydrogen in a hydrotreating reactor comprising a hydrotreating catalyst at hydrotreating conditions to produce a product stream, wherein the reformate stream comprises at least 50% less diolefins than the hydrocarbon stream and the product stream comprises at least 99% less diolefins than the hydrocarbon stream.

Systems described herein may comprise a reforming reactor comprising a reforming catalyst configured to receive a hydrocarbon stream, wherein the hydrocarbon stream comprises at least about 20 weight percent of olefins and from 0.001 to about 30 weight percent of diolefins, the hydrocarbon stream is contacted with a reforming catalyst in the reforming reactor at reforming conditions comprising temperatures of from about 700° F. to about 1200° F. and pressures of from about 20 psig to about 300 psig to produce a reformate stream, and a hydrotreating reactor configured to receive the reformate stream.

### BRIEF DESCRIPTION OF THE DRAWINGS

The following FIGURE is included to illustrate certain aspects of the present disclosure, and should not be viewed as exclusive embodiments. The subject matter disclosed is capable of considerable modifications, alterations, combinations, and equivalents in form and function, as will occur to those skilled in the art and having the benefit of this disclosure.

The FIGURE is a simplified schematic flow diagram illustrating the method and system of the disclosure.

### DETAILED DESCRIPTION OF THE INVENTION

This disclosure relates to upgrading hydrocarbon feedstocks, in particular, olefin-containing naphtha feedstocks, into higher octane and purer reformate. More specifically, the reforming of olefin-containing naphtha feedstocks does not require a diolefin saturation step and eliminates the need to add hydrogen in a pretreatment step. Further, the method and system of the present disclosure eliminate the need for hydrotreating the feedstock prior to the reforming step.

To facilitate an understanding of the present invention, a number of terms and phrases are defined below.

### Definitions

For purposes of this disclosure and the claims hereto, the numbering scheme for the Periodic Table Groups is according to the IUPAC Periodic Table of Elements (Dec 1, 2018).

As used in the present disclosure and claims, the singular forms “a,” “an,” and “the” include plural forms unless the context clearly dictates otherwise.

The term “and/or” as used in a phrase such as “A and/or B” herein is intended to include “A and B”, “A or B”, “A”, and “B”.

The term “Cn” hydrocarbon means hydrocarbon(s) having n carbon atom(s) per molecule, wherein n is a positive integer. The term “Cₙ₊” hydrocarbon means hydrocarbon having at least n carbon atom(s) per molecule, where n is an integer greater than 0. This includes paraffins, olefins, cyclic hydrocarbons, and aromatics and isomers thereof. Similarly, the term “Cₙ₋” refers to a hydrocarbon composition defined by hydrocarbons having n or fewer carbon atoms, wherein n is an integer greater than 0. This includes paraffins, olefins, cyclic hydrocarbons, aromatics, and isomers thereof.

The term “hydrocarbon” means a class of compounds containing hydrogen bound to carbon, and encompasses (i) saturated hydrocarbon, (ii) unsaturated hydrocarbon, (iii) mixtures of hydrocarbons, and including mixtures of hydrocarbon compounds (saturated and/or unsaturated) having different values of n.

The terms “alkane” and “paraffinic hydrocarbon” mean substantially-saturated compounds containing hydrogen and carbon only, e.g., those containing ≤1% (molar basis) of unsaturated carbon atoms. As an example, the term alkane encompasses C₂ to C₂₀ linear, iso, and cyclo-alkanes. Aliphatic hydrocarbon means hydrocarbon that is substantially free of hydrocarbon compounds having carbon atoms arranged in one or more rings.

The terms “unsaturate” and “unsaturated hydrocarbon” refer to one or more C₂₊ hydrocarbon compounds which contain at least one carbon atom directly bound to another carbon atom by a double or triple bond.

The terms “olefin” and “olefinic hydrocarbon,” alternatively referred to as “alkene,” refer to one or more unsaturated hydrocarbon compounds containing at least one carbon atom directly bound to another carbon atom by a double bond. In other words, an olefin is a compound which contains at least one pair of carbon atoms, where the first and second carbon atoms of the pair are directly linked by a double bond. An olefin may be straight chain or branched chain. Non-limiting examples include ethylene, propylene, butylene, and pentene. “Olefin” is intended to embrace all structural isomeric forms of olefins.

The terms “diolefin” and “diene” refer to one or more unsaturated hydrocarbon compounds containing two double bonds between carbon atoms. In other words, a diolefin is a compound that contains two pairs of carbon atoms, where the first and second carbon atoms of the pair are directly linked by a double bond. A diolefin may be straight chain or branched chain. Non-limiting examples include butadiene, pentadiene, and hexadiene. “Diolefin” is intended to embrace all structural isomeric forms of diolefins.

The terms “aromatics” and “aromatic hydrocarbon” mean unsaturated cyclic hydrocarbons having a delocalized conjugated 7E system and having from six to thirty carbon atoms (e.g., aromatic C₆-C₃₀ hydrocarbon). Examples of suitable aromatics include, but are not limited to, benzene, toluene, xylenes, mesitylene, ethylbenzenes, cumene, naphthalene, methylnaphthalene, dimethylnaphthalenes, ethylnaphthalenes, acenaphthalene, anthracene, phenanthrene, tetraphene, naphthacene, benzanthracenes, fluoranthrene, pyrene, chrysene, triphenylene, and the like, and combinations thereof. Additionally, an aromatic may comprise one or more heteroatoms. Examples of heteroatoms include, but are not limited to, nitrogen, oxygen, and/or sulfur. Aromatics with one or more heteroatoms include, but are not limited to, thiophene, benzothiophene, oxazole, thiazole and the like, and combinations thereof An aromatic may comprise monocyclic, bicyclic, tricyclic, and/or polycyclic rings (in any embodiment, at least monocyclic rings, only monocyclic and bicyclic rings, or only monocyclic rings) and may be fused rings. As used herein, the plural use of “xylenes” and grammatical variations thereof is used to convey that the xylene may be any isomer of xylene, including m-xylene, o-xylene, p-xylene, or any blend thereof.

As used herein, and unless otherwise specified, the term “paraffin,” alternatively referred to as “alkane,” and grammatical derivatives thereof, refers to a saturated hydrocarbon chain of one to about thirty carbon atoms in length, such as, but not limited to, methane, ethane, propane and butane. A paraffin may be straight chain, cyclic or branched chain. “Paraffin” is intended to embrace all structural isomeric forms of paraffins. The term “acyclic paraffin” refers to straight chain or branched chain paraffins. The term “isoparaffin” refers to branched chain paraffins and the term “n-paraffin” or “normal paraffin” refers to straight chain paraffins.

Unless otherwise specified, “naphtha,” (and grammatical variations thereof) refers to a composition that falls within the boiling point range boundaries of full-range naphtha and may have the same T₅-T₉₅ range as full-range naphtha or may have different T₅ and/or T₉₅ temperatures than full-range naphtha. Naphtha may comprise full-range naphtha, light naphtha, heavy naphtha, or any other contemplated fraction defined by a subset of hydrocarbons having, for example, a defined T₅ and/or T₉₅ temperature, a defined molecular weight range, a defined number of hydrocarbons, and the like. Naphtha may include paraffins, olefins, naphthenes, and/or aromatics.

As used herein, “feedstock” and “feed” (and grammatical derivatives thereof) are used interchangeably and both refer to a composition that is fed into a reforming reactor. A feedstock may optionally have been pre-treated to modify its disposition.

The term “reactor,” and grammatical derivatives thereof, refers to a vessel comprising one or more catalyst beds.

The term “straight run naphtha” (also termed “virgin naphtha”) refers to petroleum naphtha obtained directly from fractional distillation. The term “cracked naphtha” refers to naphtha produced by catalytic cracking. The term “coker naphtha” refers to naphtha produced by the well-known process of coking in one or more coker units or cokers. Coker naphtha generally includes more sulfur and/or nitrogen than straight run naphtha.

A common method for characterizing the octane number of a composition is to use Research Octane Number (RON). As used herein, “octane number” and “RON” are used interchangeably, and both refer to the RON of the C₅₊ fraction of a hydrocarbon product stream. Although various methods are available for determining RON, in the claims below, references to Research Octane Number (RON) correspond to RON determined as described in Ghosh, P. et al. (2006) “Development of Detailed Gasoline Composition-Based Octane Model,” Ind. Eng. Chem. Res., 45(1), pp 337-345.

The term “high octane” is meant to describe a hydrocarbon composition having a RON of at least about 80, at least about 85, at least about 90, at least about 95, at least about 99, or about 100; or in a range of about 80 to about 100, about 90 to about 100, or about 95 to about 100. RON is used herein, particularly in the Examples, as a surrogate for conversion. In any reforming reaction, a higher RON can be achieved by pushing the reaction forward with more severe operating conditions or longer run times. However, in doing so, the yield of desirable products in a hydrocarbon product stream is sacrificed. Thus, advantages are realized here in the simultaneous production of a hydrocarbon product stream having a high yield of desirable products (e.g., C₅₊ hydrocarbons, aromatics) and that desirable fraction having a high octane-rating (RON).

Another type of octane rating, called “Motor Octane Number (MON),” is determined at 900 rpm engine speed instead of the 600 rpm for RON. MON testing uses a similar test engine to that used in RON testing, but with a preheated fuel mixture, higher engine speed, and variable ignition timing to further stress the fuel's knock resistance. Depending on the composition of the fuel, the MON of a modern pump gasoline will be about 8 to 12 octane lower than the RON, but there is no direct link between RON and MON. Pump gasoline specifications typically require both a minimum RON and a minimum MON.

The term “Reid Vapor Pressure,” or “RVP” refers to the vapor pressure of the gasoline blend when the temperature is 100° F. While the octane of a particular grade is constant throughout the year, the RVP specification may change as cooler weather sets in.

The term “GCD” or “simulated distillation gas chromatography” is a technique employed to determine the boiling range distribution of petrochemical products. In simulated distillation, individual hydrocarbon components are separated in the order of their boiling points, such that laboratory-scale physical distillation procedures may be simulated. The separation may be accomplished with a gas chromatograph equipped with a chromatography column coated with a nonpolar (hydrocarbon-like) stationary phase, an oven and injector which can be temperature programmed. A flame ionization detector (FID) is used for detection and measurement of the hydrocarbon analytes. The GCD analysis provides a quantitative percent mass yield as a function of boiling point of the hydrocarbon components of the sample being analyzed. The chromatographic elution times of the hydrocarbon components are calibrated to the atmospheric equivalent boiling point (AEBP) of the individual n-alkane as described in a method from the ASTM by using n-alkane (n-paraffin) reference material. In the GCD method ASTM D2887, the n-alkane calibration reference covers the boiling range 55-538° C. (100-1000° F.) which covers the n-alkanes with a chain length of about C₅-C₄₄.

The acronym “SG” refers to the specific gravity.

The term “conditions effective to” refers to conditions to which a hydrocarbon stream or hydrocarbon feed stream may be subjected that results in a hydrocarbon product stream having a desired yield and/or octane number. Conditions may include temperature, pressure, reaction time, and the like, which are conditions known to those of ordinary skill in the art with benefit of this disclosure.

Advantages of the methods and systems described herein are apparent in an increased yield of BTX products or product fractions in a hydrocarbon product stream. As used herein, and unless otherwise specified, “percent yield” or “yield” is the total weight of the specified product divided by the total weight of the hydrocarbon stream or hydrocarbon feed stream and converted to a percent.

As used herein, the term “coke,” and grammatical derivatives thereof, refers to carbonaceous material that deposits on the surface, including within the pores, of a catalyst. Formation of coke on a catalyst's surface decreases the availability of active sites for the reforming reactions to take place. Thus, as coke builds up over time, the quality of a resulting hydrocarbon product stream may decrease.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating the invention embodiments described herein are presented herein. Not all features of a physical implementation are described or shown in this disclosure for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

### Methods and Systems for Converting Olefin-Containing Naphtha Feedstocks

Methods and systems for converting olefin-containing naphtha feedstocks are provided herein that require only two catalytic steps in order to obtain a reformate product without the need for pretreatment of the naphtha to saturate the olefins and without the need for downstream reforming.

An exemplary embodiment is illustrated in the FIGURE. A system 100 may include a feedstock stream 102 comprising an olefin-containing naphtha that is fed with preferably other light olefins contenting streams such as coker LPG and/or fuel gas to a reforming reactor 104 where at least a major portion of the olefin-containing naphtha and C₂-C₄ olefins in the feedstock 102 and contained in the reactor 104 is converted to hydrogen, methane, C₂-C₄, BTX (Benzene, Toluene, and Xylene) and aromatic containing gasoline and distillate components. This is achieved through oligomerization and reforming by exposing the olefin-containing naphtha to a catalyst, such as PZSM-5, under high severity processing conditions. The hydrogen produced can also serve to saturate the olefins present in the product. During the course of reaction, hydrogen transfer reactions result in saturation of some of the feed and intermediate olefins as well as conversion of sulfur and nitrogen compounds to H₂S and NH₃. In addition, the catalytic reforming of the naphtha converts paraffinic and naphthenic hydrocarbons in the presence of the produced hydrogen into aromatics. This process produces a liquid product of higher octane number, and substantial quantities of gases. The light gas contains some hydrogen and hydrocarbons from methane to butane. An advantage of this process is the production of the heavier gas byproduct. Sulfur converted to H₂S in the reforming step is removed by the stream 106. Although there is hydrogen in the gas, all products of catalytic reforming contain some residual olefins that need to be saturated if BTX is the desired product. In addition, for high containing sulfur feeds, the degree of the desulfurization in the reforming step is not sufficient to meet product sulfur specification, which makes a second step hydroprocessing necessary.

The intermediate or reformate stream 108 is then fed to a hydrotreating unit 110, where unconverted sulfur is converted to hydrogen sulfide. A stream of hydrogen 112 is fed into the hydrotreating unit 110. An aromatic rich product stream 114 is obtained, while hydrogen sulfide 116 is removed and a stream containing gasoline boiling range hydrocarbons containing essentially no olefins or low olefins. A C₄₋ stream 118 is also produced.

Olefin-containing Naphtha Feedstock

The olefin-containing naphtha feedstock may include naphtha produced during processing of a heavier part of crude oil. In addition, it may include naphtha produced from any C₂ and heavier component or their mixtures in a steam cracker or pyrolysis furnace. Furthermore, it may be produced in a conversion reaction of CO and H₂ to hydrocarbons. As opposed to the straight-run or virgin streams, these naphthas also contain olefinic hydrocarbons. In certain embodiments, the olefin-containing naphtha feedstock may contain at least about 20 weight percent, from about 20 weight percent to about 95 weight percent olefins, from about 20 weight percent to about 70 weight percent olefins, from about 25 weight percent to about 60 weight percent olefins, or from about 25 weight percent to about 55 weight percent olefins, and from about 1 weight percent to about 80 weight percent paraffins, from about 5 weight percent to about 55 weight percent paraffins, or from about 10 weight percent to about 50 weight percent paraffins. The olefin-containing naphtha feedstock may contain from about 2 volume percent to about 70 volume percent olefins, from about 5 volume percent to about 60 volume percent olefins, or from about 10 volume percent to about 50 volume percent olefins, and from about 1 volume percent to about 50 volume percent paraffins, from about 5 volume percent to about 45 volume percent paraffins, or from about 10 volume percent to about 40 volume percent paraffins.

The olefin-containing naphtha feedstock may further contain one or more other components, including, but not limited to, diolefins, naphthenes, aromatics, sulfur, nitrogen, and silica. For example, the olefin-containing naphtha feedstock may contain from 0 weight percent to about 30 weight percent diolefins, from about 0.001 weight percent to about 20 weight percent diolefins, or from about 0.01 weight percent to about 10 weight percent diolefins. For example, the olefin-containing naphtha feedstock may contain from 0 weight percent to about 25 weight percent naphthenes, from about 3 weight percent to about 20 weight percent naphthenes, or from about 5 weight percent to about 15 weight percent naphthenes. For example, the olefin-containing naphtha feedstock may contain from 0 weight percent to about 70 weight percent aromatics, from about 5 weight percent to about 35 weight percent aromatics, or from about 10 weight percent to about 30 weight percent aromatics. For example, the olefin-containing naphtha feedstock may contain from 0 wppm (weight parts per million) to about 7000 wppm sulfur, from about 100 wppm to about 6000 wppm weight percent sulfur, or from about 500 wppm to about 5000 wppm weight percent sulfur. The sulfur may be included in organic compounds such as thiophenes, CS₂, COS and/or RSH. The olefin-containing naphtha feedstock may contain from 0 wppm to about 550 wppm nitrogen. The olefin-containing naphtha feedstock may contain from 0 wppm to about 50 wppm silicon. Silicon within the olefin-containing naphtha feedstock may be in the form of silica (SiO₂) and/or an organosilicon compound, e.g., polydimethylsiloxane (PDMS). In certain embodiments, the olefin-containing naphtha feedstock may have a boiling range from about 10° C. to about 400° C., from about 30° C. to about 300° C., from about 40° C. to about 250° C., or from about 50° C. to about 220° C.

### Catalytic Reforming

Catalytic reforming is a process used for improving the octane quality of naphthas or straight run gasolines. Conventional catalytic reforming of hydrocarbon converts paraffinic and naphthenic hydrocarbons in the presence of a catalyst into aromatics or isomerized from straight-chain molecules to more highly branched hydrocarbons. This process produces a liquid product of higher octane number, and substantial quantities of gases. The gases are rich in hydrogen, and contain hydrocarbons from methane to pentane. Because of the excess hydrogen in the gas, essentially ppm levels of olefinic product remains. Additionally, the catalystic reforming of the method and systems of this disclosure is preferably carried out in the absence of added hydrogen.

In conventional reforming, a multi-functional catalyst is employed which contains a metal hydrogenation/dehydrogenation (hydrogen transfer) component, or components, composited with a porous, inorganic oxide support, notably alumina. In a reforming operation, one or a series of reactors constitute the reforming unit that provides a series of reaction zones. Reforming results in molecular changes, or hydrocarbon reactions, produced by dehydrogenation of cyclohexanes and dehydroisomerization of alkylcyclopentanes to yield aromatics; dehydrogenation of paraffins to yield olefins; dehydrocyclization of paraffins to yield aromatics; isomerization of n-paraffins; isomerization of alkylcycloparaffins to yield cyclohexanes; isomerization of substituted aromatics; and hydrocracking of paraffins and substituted aromatics which produces gas.

Process conditions for the instant catalytic reforming of olefin-containing naphtha streams include temperatures from about 700° F. to about 1200° F., from about 850° F. to about 1100° F., or from about 900° F. to about 1000° F.; and pressures of from about 10 psig to about 500 psig, from about 100 psig to about 400 psig, or from about 170 psig to about 350 psig; and a weight hourly space velocity of from about 0.5 hr⁻¹ to 20 hr⁻¹, or from about 0.75 hr⁻¹ to 6 hr⁻¹.

In the systems and methods of the disclosure, the olefin-containing naphtha feedstock contacts a fluid bed of an acidic catalyst under high severity conditions. For example, the olefin-containing naphtha feedstock may contact the fluid bed of an acidic catalyst at a pressure of about 300 psig at a temperature of 900° F. The acidic catalyst may be a zeolite-based catalyst, that is, it may comprise an acidic zeolite in combination with a binder or matrix material such as alumina, silica, or silica-alumina. The preferred zeolites for use in the catalysts in the present method and system are the medium pore size zeolites, especially those having the structure of ZSM-5, ZSM-12, ZSM-22, ZSM-23, ZSM-35, ZSM-48. Catalysts of this type are described in U.S. Pat. Nos. 4,827,069 and 4,992,067 which are incorporated herein by reference and to which reference is made for further details of such catalysts, zeolites and binder or matrix materials. ZSM-5 crystalline structure is readily recognized by its X-ray diffraction pattern, which is described in U.S. Pat. No. 3,702,866. ZSM-11 is disclosed in U.S. Pat. No. 3,709,979, ZSM-12 is disclosed in U.S. Pat. No. 3,832,449, ZSM-22 is disclosed in U.S. Pat. No. 4,810,357, ZSM-23 is disclosed in U.S. Pat. Nos. 4,076,842 and 4,104,151, ZSM-35 is disclosed in U.S. Pat. No. 4,016,245, ZSM-48 is disclosed in U.S. Pat. No. 4,375,573 and MCM-22 is disclosed in U.S. Pat. No. 4,954,325. The U.S. Patents identified in this paragraph are incorporated herein by reference.

The particle size of the catalyst may be selected in accordance with the fluidization regime that is used in the process. Particle size distribution will be important for maintaining turbulent fluid bed conditions as described in U.S. Pat. No. 4,827,069 and incorporated herein by reference. Suitable particle sizes and distributions for operation of dense fluid bed and transport bed reaction zones are described in U.S. Pat. Nos. 4,827,069 and 4,992,607 both incorporated herein by reference. Particle sizes in both cases will normally be in the range of 10 to 300 microns, typically from 20 to 100 microns.

These catalysts are capable of converting organic sulfur compounds such as thiophenes and mercaptans to hydrogen sulfide without added hydrogen by utilizing hydrogen present in the hydrocarbon feed. Metals such as nickel may be used as desulfurization promoters.

These catalysts are also capable of simultaneously converting light olefins present in the fuel gas to more valuable gasoline range material. A fluid-bed reactor/regenerator is preferred over a fixed-bed system to maintain catalyst activity. Further, the hydrogen sulfide produced in accordance with the present invention can be removed using conventional amine based absorption processes such as those discussed hereinabove.

These catalysts are also shape-selective. As a result they are capable of increasing the concentration of the p-xylene C₈ fraction in the reformate.

While suitable zeolites having a coordinated metal oxide to silica molar ratio of 20:1 to 200:1 or higher may be used, it is advantageous to employ aluminosilicate ZSM-5 having a silica:alumina molar ratio of about 25:1 to 70:1, suitably modified. A typical zeolite catalyst component having Bronsted acid sites may consist essentially of crystalline aluminosilicate having the structure of ZSM-5 zeolite with 5 to 95 wt. % silica, clay and/or alumina binder.

These siliceous zeolites are employed in their acid forms, ion-exchanged (e.g., HZSM-5 and PZSM-5) or impregnated with one or more suitable metals, such as Ga, Pd, Zn, Ni, Co and/or other metals of Periodic Groups III to VIII. The zeolite may include other components, generally one or more metals of group IB, IIB, IIIB, VA, VIA or VIIIA of the Periodic Table (IUPAC).

Useful hydrogenation components may include the noble metals of Group VIIIA, especially platinum, but other noble metals, such as palladium, gold, silver, rhenium or rhodium, may also be used. Base metal hydrogenation components may also be used, especially nickel, cobalt, molybdenum, tungsten, copper or zinc.

The catalyst materials may include one or more catalytic components, which components may be present in admixture or combined in a unitary multifunctional solid particle.

In addition to the preferred aluminosilicates, the gallosilicate, ferrosilicate and “silicalite” materials may be employed. ZSM-5, HZSM-5 and PZSM-5 zeolites are particularly useful in the process because of their regenerability, long life and stability under the severe conditions of operation of the methods and systems described herein. Usually the zeolite crystals have a crystal size from about 0.01 to over 2 microns or more, with 0.02-1 micron being preferred.

The catalysts may be continuously added to the reactor, thus avoiding the need to shut down the reactor where the catalytic reforming takes place for extended periods of time, e.g., 7 to 8 years.

The reformate stream produced by catalytic reforming of the olefin-containing naphtha feedstock may contain a product with a higher octane number than that of the olefin-containing naphtha feedstock. More particularly, the reformate stream may contain more aromatics than the olefin-containing naphtha feedstock. The reformate stream may contain aromatics in a range of from about 55 weight percent to about 90 weight percent, from about 60 weight percent to about 85 weight percent, or from about 65 weight percent to about 80 weight percent. The reformate stream may contain at least 100% more aromatics than the hydrocarbon stream, at least 150% more aromatics than the hydrocarbon stream, or at least 200% more aromatics than the hydrocarbon stream. The reformate stream may contain less olefins than the olefin-containing naphtha feedstock. The reformate stream may contain at least 50% less diolefins than the hydrocarbon stream, at least 65% less diolefins than the hydrocarbon stream, at least 70% less diolefins than the hydrocarbon stream, at least 75% less diolefins than the hydrocarbon stream, at least 85% less diolefins than the hydrocarbon stream, or at least 95% less diolefins than the hydrocarbon stream. The reformate stream may contain less diolefins than the olefin-containing naphtha feedstock. The reformate stream may contain at least 50% less diolefins than the hydrocarbon stream, at least 60% less diolefins than the hydrocarbon stream, at least 70% less diolefins than the hydrocarbon stream, at least 75% less diolefins than the hydrocarbon stream, at least 85% less diolefins than the hydrocarbon stream, or at least 95% less diolefins than the hydrocarbon stream.

In addition, the reformate stream may contain less paraffin than the olefin-containing naphtha feedstock. The reformate stream may contain paraffin in a range of from about 1 weight percent to about 30 weight percent, from about 5 weight percent to about 25 weight percent, or from about 7 weight percent to about 20 weight percent. The reformate stream may contain less naphthene than the olefin-containing naphtha feedstock. The reformate stream may contain naphthtene in a range of from about 1 weight percent to about 15 weight percent, from about 2 weight percent to about 10 weight percent, or from about 3 weight percent to about 7 weight percent. The reformate stream may contain less sulfur than the olefin-containing naphtha feedstock. The reformate stream may contain sulfur in a range of from 0 wppm to about 2500 wppm, from about 500 wppm to about 2000 wppm, or from about 1000 wppm to about 2000 wppm. For example, the reformate stream may comprise at least 30% less sulfur than the olefin-containing naphtha feedstock, at least 40% less sulfur than the olefin-containing naphtha feedstock, or at least 50% less sulfur than the olefin-containing naphtha feedstock.

### Hydrotreating

The term “hydrotreating” is used as a general process term descriptive of the reactions in which a prevailing degree of hydrodesulfurization occurs. Olefins saturation takes place as well and its degree depends on the catalyst and operating conditions selected. For example, hydroprocessing in Scanfining results in a lower degree of olefins saturation relative to hydrodesulfurization. When BTX production is desired, it is important to achieve a high degree of olefins saturation and when gasoline production is desired, a process like Scanfining is preferred.

The temperature of the hydrotreating step is suitably maintained from about 400° F. to about 850° F., or from about 500° F. to about 800° F., with the exact selection dependent on the desulfurization desired for a given feed and catalyst. Because the hydrogenation reactions that take place in this step are exothermic, a rise in temperature takes place along the reactor. The conditions in the hydrodesulfurization step may be adjusted to obtain the desired degree of desulfurization. A temperature rise of about 20° F. to about 200° F. is typical under most hydrotreating conditions and with reactor inlet temperatures in the preferred 500° F. to 800° F. range.

In the hydrotreating of the intermediate or reformate stream, low to moderate pressures may be used, typically from about 50 psig to about 1500 psig, or from about 300 psig to about 1000 psig. Pressure will normally be chosen to maintain the desired aging rate for the catalyst in use. The space velocity may be from about 0.5 to 10 hr⁻¹, or from about 1 to about 6 hr⁻¹. The hydrogen to hydrocarbon ratio in the feed may be from about 90 to about 900 n.1.1⁻¹, or from about 180 to about 445 n.1.1⁻¹. The extent of the desulfurization will depend on the feed sulfur content and, of course, on the product sulfur specification with the reaction parameters selected accordingly.

The catalyst used in the hydrodesulfurization step is suitably a conventional desulfurization catalyst made up of a Group VI and/or a Group VIII metal on a suitable substrate. The Group VI metal is usually molybdenum or tungsten and the Group VIII metal usually nickel or cobalt. Combinations such as Ni-Mo or Co-Mo are typical. Other metals that possess hydrogenation functionality are also useful in this service. The support for the catalyst is conventionally a porous solid, usually alumina, or silica-alumina but other porous solids such as magnesia, titania (titanium dioxide), or silica, either alone or mixed with alumina or silica-alumina may also be used, as convenient. Co-Mo catalyst is a preferred catalyst since it preserves the aromatic content of the feed.

The particle size and the nature of the hydrotreating catalyst will usually be determined by the type of hydrotreating process which is being carried out, such as: a down-flow, liquid phase, fixed bed process; an up-flow, fixed bed, trickle phase process; an ebullating, fluidized bed process; or a transport, fluidized bed process. All of these different process schemes are generally well known in the petroleum arts, and the choice of the particular mode of operation is a matter left to the discretion of the operator, although the fixed bed arrangements are preferred for simplicity of operation.

The product stream produced by the methods and systems of this disclosure may contain a product with a higher octane number than that of the olefin-containing naphtha feedstock. More particularly, the product stream may contain more aromatics than the olefin-containing naphtha feedstock. The product stream may contain aromatics in a range of from about 55 weight percent to about 90 weight percent, from about 60 weight percent to about 85 weight percent, or from about 65 weight percent to about 80 weight percent. The product stream may contain at least 100% more aromatics than the hydrocarbon stream, at least 150% more aromatics than the hydrocarbon stream, or at least 200% more aromatics than the hydrocarbon stream. The product stream may contain less olefins than the olefin-containing naphtha feedstock. The product stream may contain olefins in a range of from about 0.01 weight percent to about 20 weight percent, from about 0.05 weight percent to about 5 weight percent, or from about 1 weight percent to about 5 weight percent. The product stream may contain at least 50% less diolefins than the hydrocarbon stream, at least 75% less diolefins than the hydrocarbon stream, at least 85% less diolefins than the hydrocarbon stream, or at least 95% less diolefins than the hydrocarbon stream. The product stream may contain less diolefins than the olefin-containing naphtha feedstock. The product stream may contain diolefins in a range of from about 0.01 weight percent to about 5 weight percent, from about 0.05 weight percent to about 5 weight percent, or from about 0.1 weight percent to about 1 weight percent. The product stream may contain at least 75% less diolefins than the hydrocarbon stream, at least 85% less diolefins than the hydrocarbon stream, or at least 95% less diolefins than the hydrocarbon stream.

In addition, the product stream may contain less paraffin than the olefin-containing naphtha feedstock. The product stream may contain paraffin in a range of from about 1 weight percent to about 30 weight percent, from about 5 weight percent to about 25 weight percent, or from about 7 weight percent to about 20 weight percent. The product stream may contain less naphthene than the olefin-containing naphtha feedstock. The product stream may contain naphthtene in a range of from about 1 weight percent to about 15 weight percent, from about 2 weight percent to about 10 weight percent, or from about 3 weight percent to about 7 weight percent. The product stream may contain less sulfur than the olefin-containing naphtha feedstock. The product stream may contain sulfur in a range of from about 0 wppm to about 2500 wppm, from about 100 wppm to about 2000 wppm, or from about 300 wppm to about 2000 wppm. For example, the product stream may comprise at least 30% less sulfur than the olefin-containing naphtha feedstock, at least 50% less sulfur than the olefin-containing naphtha feedstock, or at least 70% less sulfur than the olefin-containing naphtha feedstock.

Due to the shape-selectivity of the catalyst, the product stream may have a concentration of p-xylene higher than that of the of hydrocarbon stream. Further, the product stream may have a higher octane number than that of the hydrocarbon stream, e.g., a RON of at least 90, at least 95, or at least 99.

Accordingly, the methods and systems of the present invention advantageously upgrade olefin-containing naphtha using a shape selective catalyst, which is effective for increasing the concentration of p-xylene in the reformate product. Further, the methods and systems for upgrading olefin-containing naphtha using operating conditions severe enough to convert at least 75% of diolefins from the feedstock and to obtain a high octane product, which does not require further downstream reforming.

### EXAMPLES EMBODIMENTS

A first example embodiment is a method comprising: injecting a hydrocarbon stream comprising at least about 20 weight percent of olefins and from 0.001 to about 30 weight percent of diolefins in a reforming reactor comprising a reforming catalyst at reforming conditions comprising temperatures of from about 700° F. to about 1200° F. and pressures of from about 10 psig to about 500 psig to produce a reformate stream; and contacting the reformate stream with an atmosphere comprising hydrogen in a hydrotreating reactor comprising a hydrotreating catalyst at hydrotreating conditions to produce a product stream, wherein the reformate stream comprises at least 50% less diolefins than the hydrocarbon stream and the product stream comprises at least 95% less diolefins than the hydrocarbon stream. Optionally this method can further include one or more of the following: Element 1: wherein injecting the hydrocarbon stream in the reforming reactor is carried out in the absence of added hydrogen; Element 2: wherein the reformate stream comprises at least 85% less diolefins than the hydrocarbon stream; Element 3: further comprising removing hydrogen sulfide from the reformate stream; Element 4: wherein the product stream comprises at least 75% less olefins than the hydrocarbon stream; Element 5: wherein the product stream comprises at least 95% less olefins than the hydrocarbon stream; Element 6: wherein the hydrocarbon stream comprises from 0 wppm to about 7000 wppm sulfur; Element 7: wherein the product stream comprises at least 30% less sulfur than the hydrocarbon stream; Element 8: wherein the product stream comprises at least 50% less sulfur than the hydrocarbon stream; Element 9: wherein the hydrocarbon stream comprises from about 2 to about 40 weight percent of aromatics; Element 10: wherein the product stream comprises from about 55 to about 90 weight percent aromatics; Element 11: wherein the reforming catalyst comprises a zeolite; Element 12: wherein the zeolite is ZSM-5, PZSM-5, HZSM-5, or a mixture thereof; Element 13: wherein the reforming conditions comprise a temperature of 900° F. and a pressure of 300 psig; Element 14: wherein the product stream comprises a concentration of p-xylene higher than that of the hydrocarbon stream. Examples of combinations of the foregoing include, but are not limited to, Element 1 in combination with one or more of Elements 2-14; Element 1 in combination with one or more of

Elements 2 and 3 and two or more of Elements 4-12; Element 1 in combination with Element 2 and one or more of Elements 3-10. Element 1 in combination with Element 2 and two or more of Elements 3-10. Element 1 in combination with Element 2 and one or more of Elements 11-14. Element 1 in combination with Element 2 and two or more of Elements 11-14.

A second example embodiment is a system comprising: a reforming reactor comprising a reforming catalyst configured to receive a hydrocarbon stream, wherein the hydrocarbon stream comprises at least about 20 weight percent of olefins and from 0.001 to about 30 weight percent of diolefins, the hydrocarbon stream is contacted with a reforming catalyst in the reforming reactor at reforming conditions comprising temperatures of from about 700° F. to about 1200° F. and pressures of from about 20 psig to about 300 psig to produce a reformate stream, and a hydrotreating reactor configured to receive the reformate stream. Optionally this system can further include one or more of the following: Element 15: wherein the hydrocarbon stream is contacted with a reforming catalyst in the absence of added hydrogen in the reforming reactor; Element 16: wherein the hydrotreating reactor comprises a hydrotreating catalyst at hydrotreating conditions comprising temperatures of from about 400° F. to about 850° F. and pressures of from about 50 psig to about 1500 psig. Examples of combinations of the foregoing include, but are not limited to, Elements 11 in combination with one or more of Elements 13, 15, and 16; Element 15 in combination with Element 16; Element 15 in combination with Element 13.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating the invention embodiments disclosed herein are presented herein. Not all features of a physical implementation are described or shown in this disclosure for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

To facilitate a better understanding of the embodiments of the present invention, the following example of a preferred or representative embodiment is given. In no way should the following example be read to limit, or to define, the scope of the invention.

### EXAMPLE

In the Example reported in the following Tables, a gasoline C₅₊ feed containing olefins, aromatics, paraffins, naphthenes, and dienes was fed into a reactor containing a PZSM-5 catalyst at 900° F., at 300 psig and at a WHSV of about 2.7 hr⁻¹. Table 1 shows the amounts in wt % of components in the feed and the yields in wt % of products obtained using the method and system disclosed herein. Table 2 shows the difference between the product and feed for each of the components. Table 3 shows the amounts in wt % of components in the feed and the yields in wt % of the specific C₅₊ components and the MON, RON, ΔMON, ΔRON, ΔRVP, SG, sulfur content, and GCD of the feed and product.

TABLE 1

| Components | Feed (wt %) | Product (wt %) |
|---|---|---|
| C₂₋ | | 0.76 |
| C₃ | | 8.35 |
| C₃₌ | | 0.86 |
| iC₄ | 0.14 | 3.13 |
| nC₄ | 1.02 | 3.53 |
| C₄₌ | 2.31 | 2.92 |
| Gasoline (C₅₊₎ | 96.53 | 80.0 |
| Coke | | 0.45 |

TABLE 2

| | ΔYield (Product − Feed) |
|---|---|
| ΔC₂₋ | 0.8 |
| ΔC₃ | 8.4 |
| ΔC₃₌ | 0.9 |
| ΔiC₄ | 3.0 |
| ΔnC₄ | 2.5 |
| ΔC₄₌ | 0.6 |
| ΔGasoline (C₅₊) | −16.5 |

TABLE 3

| C₅₊ Components | Feed (wt %) | Product (wt %) |
|---|---|---|
| Aromatics | 21.1 | 70.6 |
| Benzene | 1.3 | 4.4 |
| Toluene | 3.3 | 16.7 |
| Xylenes | 3.1 | 16.9 |
| l-Paraffins | 14.9 | 10.7 |
| Naphthenes | 9.0 | 4.7 |
| Olefins | 29.5 | 0.4 |
| Paraffin | 10.6 | 7.2 |
| Dienes | 4.4 | 0.5 |
| Cyclo olefins | 4.5 | 0.3 |
| Unidentified | 6.0 | 5.8 |
| MON (calc. C₅₊ to 430° F.) | 76.5 | 85.4 |
| RON (calc C₅₊ to 430° F.) | 85.7 | 97.7 |
| ΔMON (calc. C₅₊ to 430° F.) | | 8.9 |
| ΔRON (calc. C₅₊ to 430° F.) | | 11.9 |
| ΔRVP (calculated and adjusted) | | −1.1 |
| SG (experimental) | 0.765 | 0.856 |
| Sulfur (ASTM D5453), mg/kg (wppm) | 3642 | 1771 |
| GCD (ASTM D2887) | | |
| 90%, ° F. | 413 | 460 |
| 95%, ° F. | 434 | 546 |
| 99%, ° F. | 497 | 726 |
| FBP, ° F. | 567 | 768 |
| Nominal Mat Bal, wt % | | 106 |

This example shows that 51% of the sulfur contained in the feed stream was converted to hydrogen sulfide. This example also shows significant olefin conversion and octane uplift as well as increases in aromatic contents (in particular xylenes), and decreases in olefin and diolefin contents.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While the methods and systems are described in terms of “comprising,” “containing,” or “including” various components or steps, the compositions and methods can also “consist essentially of ” or “consist of ” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee.

The invention claimed is:

1. A method comprising:
injecting a hydrocarbon stream comprising at least about 20 weight percent of olefins and from 0.001 to about 30 weight percent of diolefins in a reforming reactor comprising a reforming catalyst at reforming conditions comprising temperatures of from about 700° F. to about 1200° F. and pressures of from about 10 psig to about 500 psig to produce a reformate stream; and
contacting the reformate stream with an atmosphere comprising hydrogen in a hydrotreating reactor comprising a hydrotreating catalyst at hydrotreating conditions to produce a product stream,
wherein the reformate stream comprises at least 50% less diolefins than the hydrocarbon stream and the product stream comprises at least 95% less diolefins than the hydrocarbon stream.

2. The method of claim 1, wherein injecting the hydrocarbon stream in the reforming reactor is carried out in the absence of added hydrogen.

3. The method of claim 1, wherein the reformate stream comprises at least 85% less diolefins than the hydrocarbon stream.

4. The method of claim 1, further comprising removing hydrogen sulfide from the reformate stream.

5. The method of claim 1, wherein the product stream comprises at least 75% less olefins than the hydrocarbon stream.

6. The method of claim 1, wherein the product stream comprises at least 95% less olefins than the hydrocarbon stream.

7. The method of claim 1, wherein the hydrocarbon stream comprises from 0 wppm to about 7000 wppm sulfur.

8. The method of claim 1, wherein the product stream comprises at least 30% less sulfur than the hydrocarbon stream.

9. The method of claim 1, wherein the product stream comprises at least 50% less sulfur than the hydrocarbon stream.

10. The method of claim 1, wherein the hydrocarbon stream comprises from about 2 to about 40 weight percent of aromatics.

11. The method of claim 1, wherein the product stream comprises from about 55 to about 90 weight percent aromatics.

12. The method of claim 1, wherein the reforming catalyst comprises a zeolite.

13. The method of claim 12, wherein the zeolite is ZSM-5, PZSM-5, HZSM-5, or a mixture thereof.

14. The method of claim 1, wherein the reforming conditions comprise a temperature of 900° F. and a pressure of 300 psig.

15. The method of claim 1, wherein the product stream comprises a concentration of p-xylene higher than that of the hydrocarbon stream.

16. A system comprising:
a reforming reactor comprising a reforming catalyst configured to receive a hydrocarbon stream, wherein the hydrocarbon stream comprises at least about 20 weight percent of olefins and from 0.001 to about 30 weight percent of diolefins, the hydrocarbon stream is contacted with a reforming catalyst in the reforming reactor at reforming conditions comprising temperatures of from about 700° F. to about 1200° F. and pressures of from about 20 psig to about 300 psig to produce a reformate stream, and
a hydrotreating reactor configured to receive the reformate stream.

17. The system of claim 16, wherein the hydrocarbon stream is contacted with a reforming catalyst in the absence of added hydrogen in the reforming reactor.

18. The system of claim 16, wherein the reforming catalyst comprises a zeolite.

19. The system of claim 16, wherein the reforming conditions comprise a temperature of 900° F. and a pressure of 300 psig.

20. The system of claim 16, wherein the hydrotreating reactor comprises a hydrotreating catalyst at hydrotreating conditions comprising temperatures of from about 400° F. to about 850° F. and pressures of from about 50 psig to about 1500 psig.
